(19) United States
(12) Patent Application Publication
(10) Pub. No.: US 2025/0167580 A1
(43) Pub. Date: May 22, 2025

(54) METHOD FOR ULTRA-RAPIDLY CHARGING AN ELECTROCHEMICAL ACCUMULATOR CELL

(71) Applicant: COMMISSARIAT A L’ENERGIE ATOMIQUE ET AUX ENERGIES ALTERNATIVES, PARIS (FR)

(72) Inventors: Lara CASIEZ, GRENOBLE (FR); Jacopo CELE, GRENOBLE (FR); Sami OUKASSI, GRENOBLE (FR)

(21) Appl. No.: 18/939,188

(22) Filed: Nov. 6, 2024

(30) Foreign Application Priority Data
Nov. 17, 2023 (FR) 2312650

(51) Int. Cl. H02J 7/00

(52) U.S. Cl. CPC H02J 7/00716; H02J 7/0048

(57) ABSTRACT

A method for charging an electrochemical accumulator cell, wherein the voltage across the terminals of the cell is kept constant at at least two successive predefined voltage levels, the charging current delivered to the cell decreasing gradually as the battery charges, the method including: E1) a first step, of applying a first voltage to the terminals of the cell, the first voltage being greater than a normal charging voltage, the normal charging voltage being defined as being a voltage such that it would not cause the cell to deteriorate electrochemically if it was applied over a complete charging cycle of the cell; E2) a second step, of applying the normal charging voltage.

### CROSS-REFERENCE TO RELATED APPLICATION

This application claims priority to foreign French patent application No. FR 2312650, filed on Nov. 17, 2023, the disclosure of which is incorporated by reference in its entirety.

### FIELD OF THE INVENTION

The present invention relates to a method for charging an electrochemical accumulator cell, as well as to a system which is able to implement the method.

### BACKGROUND

An electrochemical accumulator cell is the basic unit of a battery or of an electrochemical accumulator. It is composed of two electrodes (an anode and a cathode) and of an electrolyte which makes the chemical reactions which generate electrical energy possible.

The electrochemical cells in a battery are connected in series or in parallel, or by a combination of the two, as a function of the voltage and of the capacity which are required for the specific application.

The charging speed of a cell depends on many factors, notably the capacity of the cell, the technology of the cell, the charging current, and indeed the safety features.

There are several documents from the prior art which aim to reduce the charging time of a cell.

Document [1] describes an adaptive charging protocol implemented in order to rapidly charge a rechargeable battery having electrode terminals which are connected to the terminals of an electric power supply which is provided in order to apply time-variable voltages to the electrodes, comprising, before beginning a charging operation for the battery, the steps consisting in: detecting the existence of historical data on the previous charging operations of the battery; if detected, processing the historical data in order to adjust the charging parameters with a view to optimizing the charging operation; if not detected, electrically testing the battery in order to obtain data on the variations in the state of charge (SOC) of the battery, with a view to constructing a training model on the SOC variations to be used to optimize the charging operation.

Document [2] describes a method for rapidly charging lithium batteries which consists in charging the battery in a first phase while maximizing the charging current, then in charging the battery in a second phase while decreasing the charging current in response to an anode potential determined by a reference electrode in order to keep the anode potential at or above a threshold, then charging the battery in a third phase while decreasing the charging current in response to the cathode potential determined by the reference electrode so that the cathode potential is maximized without exceeding the cathode potential threshold. A controller may determine an anode potential or a cathode potential in real time using a cell potential signal and a cathode or anode reference electrode signal, respectively. The threshold is the anode potential above which practically no lithium plating occurs.

Document [3] describes a rechargeable battery comprising an anode, a cathode, an electrolyte arranged between the anode and the cathode, a protective housing which at least partially surrounds the anode, the cathode and the electrolyte, a heat distribution element arranged at least partially inside the protective housing and configured to receive heat originating from an external heat source at a desired heating temperature Th in order to heat the battery to a desired temperature Tc for charging the battery, which makes it possible to lower the charging time.

In these documents from the prior art, the charging time remains very long, several tens of minutes, with respect to the application specifications, all the more so as the energy density has a tendency to increase in new batteries.

There is therefore a need to provide a method for charging an electrochemical accumulator cell, which reduces the charging time significantly with respect to the methods known from the prior art.

### SUMMARY OF THE INVENTION

One subject of the invention is therefore a method for charging an electrochemical accumulator cell, wherein the voltage across the terminals of the cell is kept constant at at least two successive predefined voltage levels, the charging current delivered to the cell decreasing gradually as the battery charges, the method comprising:
E1) a first step, of applying a first voltage to the terminals of the cell, the first voltage being greater than a normal charging voltage, the normal charging voltage being defined as being a voltage such that it would not cause the cell to deteriorate electrochemically if it was applied over a complete charging cycle of the cell;
E2) a second step, of applying the normal charging voltage.

Advantageously, the first step is applied for a charging parameter such that the internal resistance of the cell is not above a predetermined threshold.

Advantageously, the charging parameter is selected from among a charging capacity, a charging current, a charging voltage and a charging time.

Advantageously, the first voltage is defined by the formula:

V1=max(2.5*Vbat or 10.5V),

max corresponding to the maximum voltage and Vbat corresponding to the normal charging voltage of the cell.

Advantageously, the percentage of charging capacity generated at the normal charging voltage over the total capacity generated at the first charging voltage and at the normal charging voltage is between 10% and 50%.

Advantageously, the cell comprises an electrolyte the electronic conductivity of which is less than 10-9 (Ω·m)−1.

Advantageously, the cell comprises a solid electrolyte.

Advantageously, the electrolyte comprises one of the materials selected from among LiPON, Li3OCl, LiSiON, LIN and LATP.

The invention also relates to a system for managing the charging of a cell, characterized in that it is configured to implement the aforementioned method.

### BRIEF DESCRIPTION OF THE DRAWINGS

Other features, details and advantages of the invention will become apparent on reading the description given with reference to the appended drawings, which are given by way of example.

FIG. 1 schematically illustrates the steps of the method according to the invention.

FIG. 2 illustrates the applied voltage and the state of charge as a function of time which are obtained with the method according to the invention.

FIG. 3 illustrates the charging curve of a cell at various charging voltage values, as a function of time.

FIG. 4 illustrates the energy density delivered as a function of the number of charging/discharging cycles.

FIG. 5 illustrates the change in the internal resistance of the cell as a function of charge.

FIG. 6 illustrates the internal resistance, for various charging protocols.

FIG. 7 illustrates a comparison of the method according to the invention with charging methods which are known from the prior art.

### DETAILED DESCRIPTION

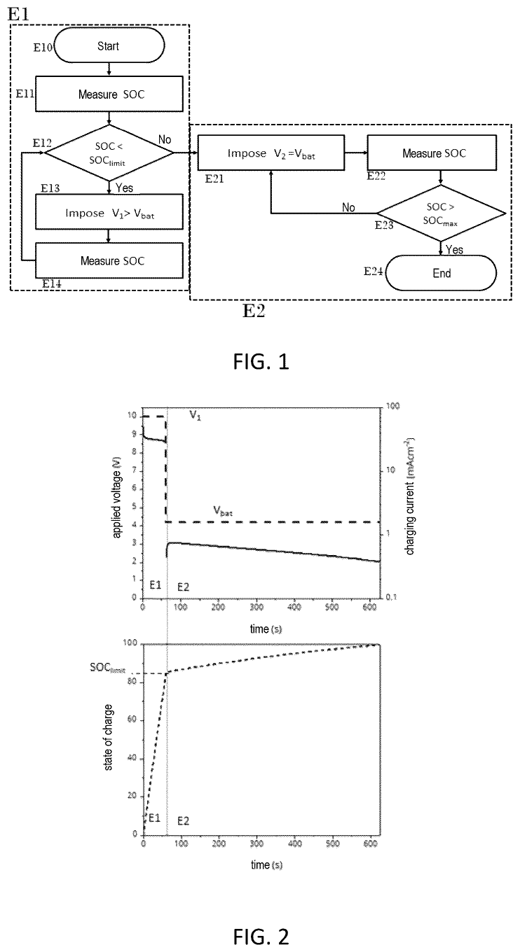

The method according to the invention is illustrated by FIG. 1. In an initial step (which is not depicted), the cell is connected to an appropriate power source, which may be a specific charger designed for the chemistry of the cell.

Optionally, and as not depicted in FIG. 1, the method may also comprise a step of delivering a rapid charging current in order to accelerate charging.

The method according to the invention comprises applying a constant voltage to the terminals of the cell, wherein the voltage is kept constant at at least two successive predefined voltage levels, the current decreasing gradually as the cell charges.

The method comprises two steps.

The first step E1 consists in applying a first voltage V1 to the terminals of the cell, the first voltage V1 being greater than a normal charging voltage Vbat. The normal charging voltage Vbat is defined as being a voltage such that it would not cause the cell to deteriorate electrochemically if it was applied over a complete charging cycle of the cell.

The normal charging voltage Vbat, also called the “charge cut-off voltage”, also corresponds to the voltage at which the cell reaches its maximum capacity at the end of the charging process. It is thus the voltage at which the cell must not be charged further in order to avoid problems with safety, with performance or with the lifetime of the battery.

For a battery comprising a plurality of cells, the normal charging voltage is calculated as a function of the total number of cells and of the series/parallel arrangement of the cells. The charging voltage of a cell is variable according to the type of anode and of cathode which are chosen. In the context of the present invention, the normal charging voltage Vbat of a lithium-ion cell equals 4.2 V.

The method begins in the substep E10. The state of charge SOC is measured in the substep E11. If the state of charge is less than a borderline state of charge SOClimit (substep E12), the first voltage V1 is applied (substep E13) then the state of charge SOC is measured (substep E14), and so on as long as the state of charge is less than a borderline state of charge SOClimit.

In FIG. 2, the state of charge increases rapidly during the first step E1 (applying the first voltage V1).

The second step E2 consists in applying the normal charging voltage (V_{bat}).

In FIG. 2, during the second step E2, the state of charge increases more slowly and the charging current decreases gradually as the battery charges.

When the cell is completely charged, the charger may either reduce the current to a very low level (charge maintenance) or stop charging completely (step which is not illustrated in FIG. 1).

In FIG. 1, the normal charging voltage Vbat is imposed (substep E21) as soon as the state of charge is greater than a borderline state of charge SOClimit (substep E12). The state of charge SOC is measured (substep E22). If the state of charge is greater than a maximum state of charge SOCmax (substep E23), the method ends (substep E24). If not, the normal charging voltage Vbat is maintained.

The maximum state of charge SOCmax is defined by the user with respect to the features of the battery. The maximum state of charge SOCmax may be defined and measured in two ways:

by the charged capacity (in μAh) by the measurement of the open-circuit voltage

In addition, once the cell has been completely charged, it may be disconnected from the power source in order to avoid overcharging which might damage the cell (step which is not illustrated in FIG. 1).

Contrary to what a person skilled in the art might believe, applying, for a certain amount of charge with respect to the total amount of charge, a voltage which is greater than the normal charging voltage has no detrimental influence on the operation of the cell and makes it possible to drastically reduce the charging time at constant capacity (from 30 minutes with a conventional charging method to 1 minute 30 with the method according to the invention).

Recall that: Charging time (h)=Capacity of the battery (A.h)/Charging current (A)

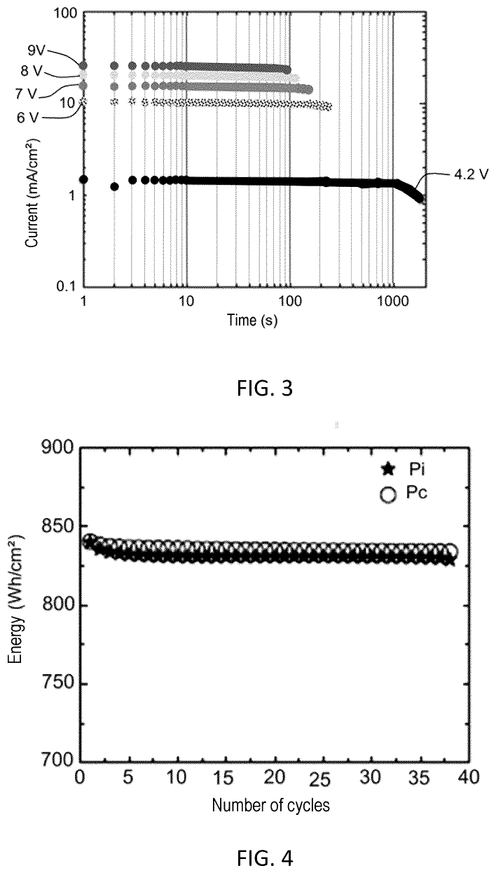

FIG. 3 illustrates this effect, for a 20 μm thick thin-film battery (TFB).

A thin-film battery, also called a micro-battery, may be defined as a battery exhibiting all the following features:

All the active layers (that is to say the positive electrode, the electrolyte and the negative electrode) consist solely of solid-state inorganic material. Generally, this means that there is no liquid or gel polymer electrolyte and no electrode material containing polymeric binders, as is the case in “standard” batteries, in the battery.

The individual thickness of all the active layers (that is to say the positive electrode, the electrolyte and the negative electrode layer) is less than 50 μm. In addition, the thickness of the electrolyte is generally less than 5 μm. For standard batteries, the thickness of each layer is generally greater than 100 μm.

The dimensions of the surface area generally vary from a few mm² to 10 cm².

With a single constant voltage level at the normal charging voltage (Vbat=4.2 V), a current which is equal to around 1 mA/cm² is reached in a micro-battery. By applying a first voltage V1 which is greater than the normal charging voltage Vbat, a current which is more than ten times greater may be obtained, without having to extend the charging process. For example, the first voltage V1 may be fixed at 6 V, 7 V, 8 V, 9 V or 10 V.

For a cell the reference voltage of which is equal to 4.2 V, the first voltage V1 may advantageously be defined by the formula:

V1=max (2.5*Vbat or 10.5 V).

max corresponds to the maximum function.

FIG. 4 illustrates a graph of the energy delivered as a function of the number of charging/discharging cycles, comparing the method according to the invention (Pi) with a conventional constant-voltage charging method (Pc) for a TFB. The energy remains constant as a function of the number of cycles, be that solely with the normal charging voltage (Vbat=4.2 V) or with a first voltage (V1=8 V) then with the normal charging voltage (Vbat=4.2 V).

According to one advantageous embodiment, the first step is applied for an amount of charge such that the internal resistance of the cell is not above a predetermined threshold during the first substep.

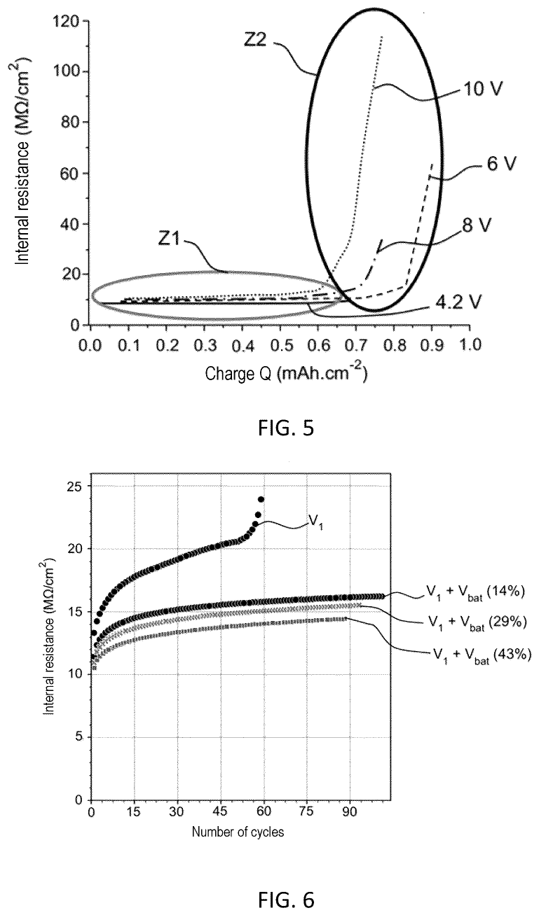

Indeed, as FIG. 5 illustrates, the internal resistance of the cell has a tendency to remain substantially constant when the constant-voltage step comprises solely applying the normal charging voltage (Vbat=4.2 V), as is the case in the methods known to a person skilled in the art. The end of charging brings about very little deterioration in the cell (internal resistance around 10 MΩ/cm²).

A constant voltage step which comprised solely applying a voltage which was greater than the normal charging voltage (for example, 6 V, 8 V or 10 V in FIG. 5) would cause the internal resistance of the cell to increase. As a function of the applied voltage, the increase in the internal resistance may be slight at the start of charging (zone Z1), then exponential during charging (zone Z2). Thus, the internal resistance must be prevented from being in the zone Z2. The method according to the invention is based on the fact that charging may start with a first voltage V1 which is greater than the normal charging voltage Vbat, so as to remain in the zone Z1, then, before the internal resistance exceeds a threshold value, the charging voltage is brought back to the normal charging voltage Vbat.

One or more intermediate voltages may be used, in order to avoid moving suddenly from the first voltage V1 to the normal charging voltage Vbat.

The charging voltage may switch from the first voltage V1 to the normal charging voltage Vbat without systematic analysis of the internal resistance. For one type of component, the moment of transition may be determined in a first stage using a graph such as that depicted in FIG. 5. The switching point may be determined on the basis of a minimum current reached or of a charged capacity reached or of a resistance measured. Once this point has been selected for one configuration, it may be imposed systematically.

In addition, the internal resistance of the cell may be determined by various methods, notably: analysing the internal voltage drop of the cell when a current is applied, sending a pulsed current to the cell and measuring the voltage response, or indeed analysing impedance by applying an AC signal to the cell.

The proportion of charge at the first voltage V1 with respect to the total amount of charge (that is to say the charge at the first voltage V1 and the charge at the maximum charging voltage Vbat) is variable. It may be chosen prior to the start of the charging cycle, as indicated above, or in real time.

FIG. 6 illustrates the cycling behaviour of a cell, with various proportions of the charge at the first voltage V1 with respect to the total charge. The cycling strength of a cell (or of a battery, by extension) refers to its capacity to repeatedly and reliably undergo charging and discharging cycles without significant deterioration of its performance or of its capacity.

As was indicated above, the consequence of a complete charge at the first voltage V1 (10 V in FIG. 6), for several charging cycles, would be a consequent increase, starting from the first charging cycles, of the value of the internal resistance of the cell.

Applying a first voltage V1 (10 V in FIG. 6) which is greater than the normal charging voltage Vbat, then applying the normal charging voltage Vbat (4.2 V in FIG. 6), with a percentage of charging capacity generated at the normal charging voltage Vbat over the total capacity generated at the first charging voltage V1 and at the normal charging voltage Vbat of between 10% and 50%, makes it possible to contain the deterioration of the cell over the charging/discharging cycles, as is visible in FIG. 6, with values of 14%, 29% and 43%. After about fifty cycles, the internal resistance tends towards a threshold value, around 16 MΩ/cm², 15 MΩ/cm² and 14 MΩ/cm², respectively.

Advantageously, the cell comprises a solid electrolyte, which makes it possible to improve the energy density of the cell. Thus, the cell may store more energy for a given size. Solid-electrolyte cells are particularly suitable for portable devices such as telephones or other connected electronic devices.

The following table describes the properties of certain electrolytes used in solid-electrolyte batteries (also called all-solid batteries):

| Electrolyte | σₑₗ (Ω · m)⁻¹ |
|---|---|
| LPS | 10⁻⁹ |
| LTP | 10⁻⁹-10⁻² |
| αLZP | 10⁻⁹ |
| LAGP | 10⁻⁹-10⁻⁸ |
| LATP | 10⁻¹⁰ |
| LGPS | — |
| LLZO | 10⁻⁸ |
| LLTO | 10⁻⁹ |
| LiPON | 10⁻¹⁵-10⁻⁹ |
| LiSiON | 10⁻¹³-10⁻⁸ |
| Li₃OCl | 10⁻¹¹ |
| LiN | 10⁻¹² |
| PEO | — |

σel corresponds to the electronic conductivity, in (Ω·m)−1.

It is apparent from the table that LiPON (lithium phosphorus oxynitride) has a very low electronic conductivity (the electronic conductivity gel is between 10-15 and 10-9 (Ω·m)−1), and may therefore be used as an electrolyte in the charging method according to the invention.

The electrolytes the electronic conductivity of which is less than 10-9 (Ω·m)−1 exhibit good performance in terms of charging rapidity. If the electronic conductivity is greater than 10-9, the electrolyte becomes a less good electrical insulator. Thus, the probability of there being electrons in this layer under an electric field is larger, therefore the probability of there being the following reaction is higher:

Li⁺+e⁻→Li

Such a reaction involves deterioration of the performance of the battery, since the lithium metal in LiPON is not mobile like the Li⁺ ion. It forms dendrites composed of lithium, which lead to a short circuit in the battery.

Other materials may be used as an electrolyte, such as Li3OCI, LiSiON, LIN and LATP (lithium aluminium titanium phosphate).

LLZTO (lithium lanthanum tantalum zirconia oxide) and LLZO (lithium lanthanum zirconate oxide) have an electronic conductivity which may be greater than 10-9 (Ω·m)−1; they are therefore incompatible with a rapid charging method, as described in [4], [5] and [6].

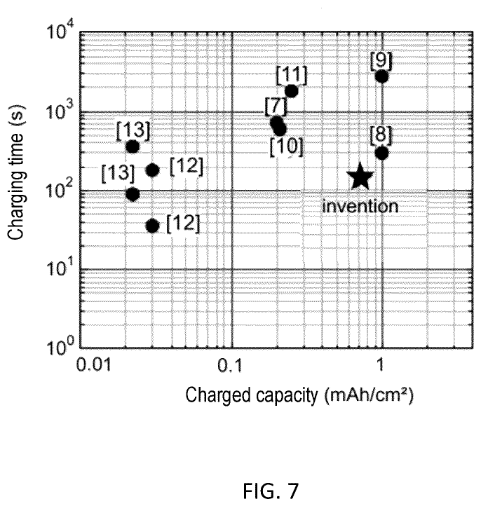

FIG. 7 illustrates the performance of the method according to the invention, compared with methods from the prior art.

The methods from the prior art which are depicted in FIG. 7 may be divided into three groups:

a first group comprises methods and [13], which make it possible to obtain a charged capacity of between 0.02 and 0.03 mAh/cm²;

a second group comprises methods [7], and [11], which make it possible to obtain a charged capacity of between 0.2 and 0.3 mAh/cm²;

a third group comprises methods [8] and [9], which make it possible to obtain a charged capacity of between 0.7 and 1 mAh/cm².

In the third group, which corresponds to the highest charging capacities among those from the comparative base, the method according to the invention makes it possible to obtain the most rapid charging time (100 seconds against 300 seconds for method [8] and 3000 seconds for method [9]).

The invention also relates to a system for managing the charging of a battery, which is configured to implement the aforementioned method. As was indicated above, the method has been described for charging an electrochemical accumulator cell. It may be extended to charging a battery comprising a plurality of cells which are connected in series and/or in parallel, without this posing any difficulty for a person skilled in the art.

The system for managing the charging of a battery may notably control the charging of the battery as a function of the parameters which are defined in order to avoid excessive overcharging, which is liable to damage the battery. For this purpose, it may comprise a computing unit which notably determines the value of the constant current during the step E1, the normal charging voltage, the duration of the step E1, the value of the first voltage V₁ and the duration of the step E2.

### REFERENCES CITED

[1] U.S. Pat. No. 11,677,102 B2.
[2] U.S. Pat. No. 10,446,883 B2.
[3] U.S. Pat. No. 11,444,339 B2.
[4] Yaoyu Ren et al. “Direct observation of lithium dendrites inside garnet-type lithium-ion solid electrolyte”. In: Electrochemistry Communications 57 (August 2015), pp. 27-30. DOI: 10.1016/j.elecom.2015.05.001.
[5] Rachna Khurana et al. “Suppression of Lithium Dendrite Growth Using Cross-Linked Polyethylene/Poly (ethylene oxide) Electrolytes: A New Approach for Practical Lithium-Metal Polymer Batteries”. In: J. Am. Chem. Soc. 136.20 (May 2014), pp. 7395-7402. DOI: 10.1021/ja502133j.
[6] Till Fuchs et al. “Current-Dependent Lithium Metal Growth Modes in “Anode-Free” Solid-State Batteries at the Cu|LLZO Interface “. In: Advanced Energy Materials 13.1 (January 2023), p. 2203174. DOI: 10.1002/aenm.202203174.
[7] N. J. Taylor et al., Journal of Power Sources, vol. 396, pp. 314-318, August 2018.
[8] K. Niitani et al., ACS Energy Lett., vol. 7, no. 1, pp. 145-149, January 2022.
[9] T. Kobayashi et al., Electrochimica Acta, vol. 53, no. 15, pp. 5045-550 Jun. 2008.
[10] G.-L. Zhu et al., Energy Storage Materials, vol. 31, pp. 267-273, October 2020.
[11] H. Yamauchi et al., Sci Rep, vol. 10, no. 1, p. 9453 Jun. 2020.
[12] Z. Wang et al., ACS Appl. Mater. Interfaces, vol. 12, no. 43, pp. 48 677-48 683, October 2020.
[13] J. Sastre et al., ACS Appl. Mater. Interfaces, vol. 12, no. 32, pp. 36 196-36 207, August 2020.

1. A method for charging at least one electrochemical accumulator cell, wherein the voltage across the terminals of the cell is kept constant at at least two successive predefined voltage levels, the charging current delivered to the cell decreasing gradually as the battery charges,
wherein the method comprises:
E1) a first step, of applying a first voltage (V₁) to the terminals of the cell, the first voltage (V₁) being greater than a normal charging voltage (V_{bat}), the normal charging voltage (V_{bat}) being defined as being a voltage such that it would not cause the cell to deteriorate electrochemically if it was applied over a complete charging cycle of the cell;
E2) a second step, of applying the normal charging voltage (V_{bat}).

2. The method according to claim 1, wherein the first step is applied for a charging parameter such that the internal resistance of the cell is not above a predetermined threshold.

3. The method according to claim 2, wherein the charging parameter is selected from among a charging capacity, a charging current, a charging voltage and a charging time.

4. The method according to claim 1, wherein the first voltage (V₁) is defined by the formula:
V₁=max(2.5*Vbat or 10.5V),
max corresponding to the maximum voltage and Vbat corresponding to the normal charging voltage of the cell.

5. The method according to claim 1, wherein the percentage of charging capacity generated at the normal charging voltage over the total capacity generated at the first charging voltage (V₁) and at the normal charging voltage (V_{bat}) is between 10% and 50%.

6. The method according to claim 1, wherein the cell comprises an electrolyte the electronic conductivity of which is less than 10-9 (Ω·m)−1.

7. The method according to claim 1, wherein the cell comprises a solid electrolyte.

8. The method according to claim 1, wherein the electrolyte comprises one of the materials selected from among LiPoN, LisOCl, LiSiON, LIN and LATP.

9. The method according to claim 1, wherein the first voltage (V₁) is applied as long as the state of charge of the electrochemical accumulator cell is less than a predefined borderline value (SOClimit).

10. The method according to claim 1, wherein the normal charging voltage (V_{bat}) is applied as long as the state of charge of the electrochemical accumulator cell is less than a predefined maximum value (SOCmax).

11. A system for managing the charging of at least one cell, configuring to implement the method according to claim 1.
